(19) United States
(12) Patent Application Publication
(10) Pub. No.: US 2026/0034694 A1
(43) Pub. Date: Feb. 5, 2026

(54) KITCHEN SLICING DEVICE

(71) Applicant: Jingsong LIAO, Shenzhen (CN)

(72) Inventor: Jingsong LIAO, Shenzhen (CN)

(21) Appl. No.: 18/830,599

(22) Filed: Sep. 11, 2024

(30) Foreign Application Priority Data
Jul. 30, 2024 (CN) 202421816538.5

(51) Int. Cl. B26D 1/08; B26D 7/06; B26D 7/26

(52) U.S. Cl. CPC B26D 1/08; B26D 7/0608; B26D 7/2614; B26D 2210/02

(57) ABSTRACT

The invention discloses a kitchen slicing device, comprising a base, a blade and a blade holder, wherein the base is provided with an object receiving portion, the blade is mounted on the blade holder, and the blade holder is slidably connected to the base to allow the blade to slide towards the object receiving portion to complete cutting. In contrast to point contact in a guillotine-type slicing device, the contact area between the slicing device of the invention and ingredients is larger, and when a force is applied the ingredients are unlikely to move and can be cut more stably, such that slices of ingredients are uniform in thickness.

### TECHNICAL FIELD

The invention belongs to the technical field of kitchenware, and specifically relates to a kitchen slicing device.

### BACKGROUND

In the kitchen, a large quantity of ingredients need to be sliced, especially cheese. Cheese needs to be cut into different sizes as needed when eaten. Guillotine-type slicing devices are often used in the prior art, such as in Patent Publication No. CN96363671B. In such type of slicing devices, blades are in point contact with ingredients at the moment of first contacting the ingredients. However, due to the small contact area between the blades and ingredients, the ingredients move easily when a force is applied, leading to non-uniform thicknesses of slices.

### SUMMARY

The objective of the invention is to provide a kitchen slicing device to solve the problems proposed in the background. To fulfill the above objective, the invention provides the following technical solution:

A kitchen slicing device comprises a base, a knife and a knife holder, wherein the base is provided with an object receiving portion, the knife is mounted on the knife holder, and the knife holder is slidably connected to the base to allow the knife to slide towards the object receiving portion to complete cutting.

The invention has the following beneficial effects: in contrast to point contact in a guillotine-type slicing device, the contact area between the slicing device of the invention and ingredients is larger, and when a force is applied the ingredients are unlikely to move and can be cut more stably, such that slices of the ingredients are uniform in thickness.

### BRIEF DESCRIPTION OF THE DRAWINGS

FIG. 1 is a structural view of a kitchen slicing device according to Embodiment 1 of the invention;

FIG. 2 is an exploded structural view of the kitchen slicing device according to Embodiment 1 of the invention;

FIG. 3 is a structural view of a kitchen slicing device according to Embodiment 2 of the invention;

FIG. 4 is an assembled structural view of a positioning rod and an adjusting mechanism according to Embodiment 2 of the invention; and

FIG. 5 is an assembled structural view of a push plate and springs according to Embodiment 2 of the invention.

### DESCRIPTION OF EMBODIMENTS

### Embodiment 1

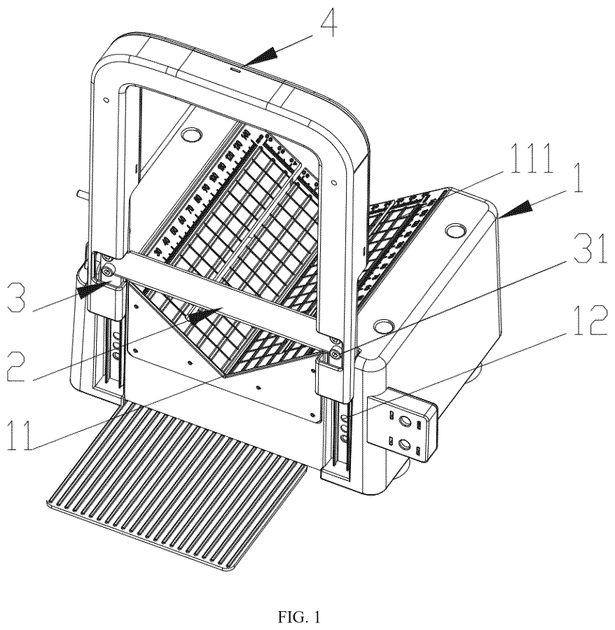

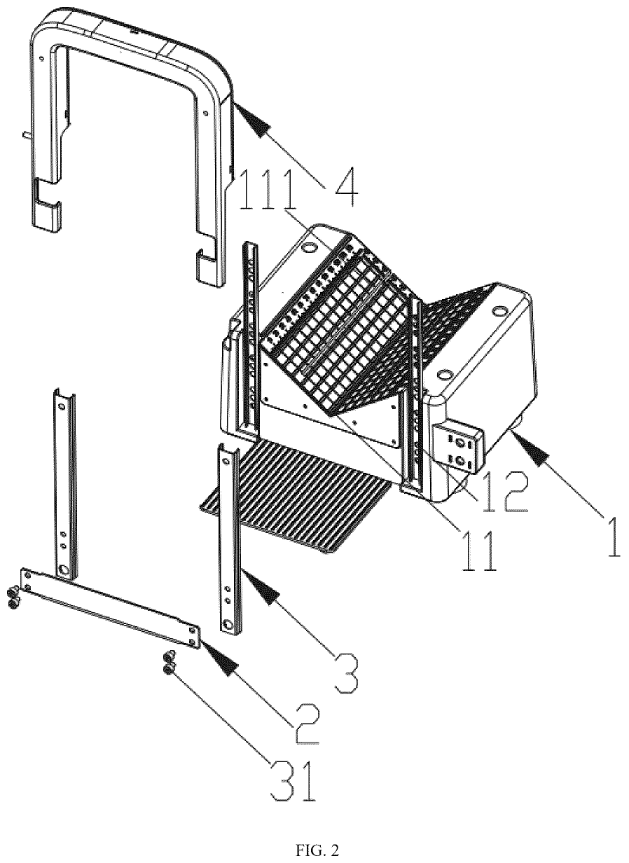

Referring to FIGS. 1 and 2, this embodiment provides a kitchen slicing device, comprising a base 1, a blade 2 and a blade holder 3, wherein the base 1 is provided with an object receiving portion 11, the blade 2 is mounted on the blade holder 3, and the blade holder 3 is slidably connected to the base 1, so that the blade 2 slides towards the object receiving portion 11 to complete cutting.

When slicing ingredient (such as cheese), the ingredient (such as cheese) is placed on the object receiving portion 11, and then the blade holder 3 is pushed to slide towards the object receiving portion 11 to slice the ingredient (such as cheese). Because the blade 2 moves in a straight line to act on the surface of the ingredient (such as cheese), the blade 2 is in line contact with the surface of the ingredient (such as cheese) at the moment of first contacting, and in contrast to point contact in a guillotine-type slicing device, the contact area between the blade and the ingredient is larger, when a force is applied the ingredient is unlikely to move and can be cut more stably, such that slices of the ingredient are uniform in thickness.

In this embodiment, referring to FIG. 2, the blade 2 is detachably connected to the blade holder 3, and optionally, the blade 2 is fixed to the blade holder 3 by screws 31. The blade 2 is detachably connected to the blade holder 3, such that when the blade 2 is damaged, it can be easily detached from the blade holder 3 to be replaced with a new blade 2.

In this embodiment, referring to FIGS. 1 and 2, a guide rail 12 is arranged on the base 1, the blade holder 3 is mounted on the guide rail 12 and is able to slide along the guide rail 12. Optionally, two blade holders 3 are arranged in parallel, two guide rails 12 are arranged in parallel correspondingly, and two ends of the blade 2 are mounted on the two blade holders 3 respectively. The guide rail 12 is used for guiding the blade holder 3 to slide, such that friction can be reduced to allow the blade holder 3 to move more smoothly, and the blade holder 3 will not get stuck during slicing.

In this embodiment, referring to FIGS. 1 and 2, the kitchen slicing device further comprises an inverted U-shaped pull rod 4, and two ends of the inverted U-shaped pull rod 4 are connected to the two blade holders 3 respectively. The inverted U-shaped pull rod 4 facilitates manual pulling of the blade holders 3.

In this embodiment, referring to FIGS. 1 and 2, the objective receiving portion 11 is in the form of a V-shaped groove with an opening facing upwards, and is provided with anti-skid stripes 111. By means of the object receiving portion 11 in the form of a V-shaped groove with the anti-skid stripes, it is conducive to further preventing the ingredient from moving when slicing.

### Embodiment 2

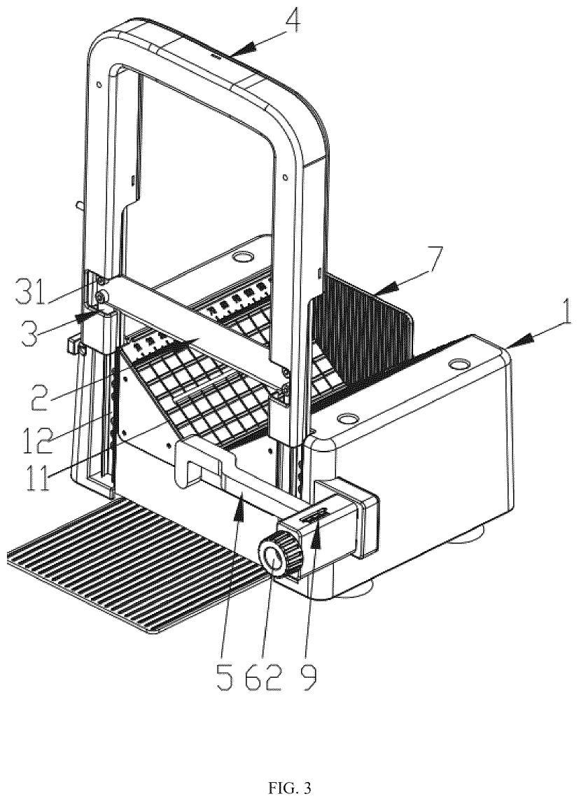

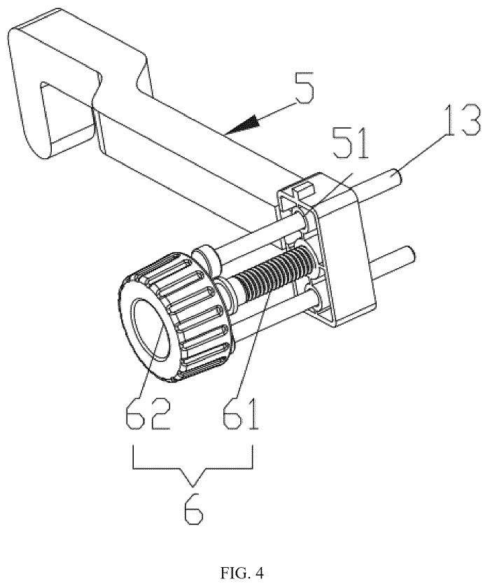

This embodiment is approximately identical with Embodiment 1 in structure, with the difference being that: referring to FIGS. 3 and 4, the kitchen slicing device further comprises a positioning rod 5 and an adjusting mechanism 6, wherein the positioning rod 5 is slidably connected to the base 1 to slide in a direction perpendicular to the sliding direction of the blade 2, and the adjusting mechanism 6 is used to adjust the sliding of the positioning rod 5. Optionally, sliding rods 13 are arranged on the base 1, sliding holes 51 are formed in the positioning rod 5, and the sliding holes 51 are fitted on the sliding rods 13 to slidably connect the positioning rod 5 to the base 1. When slicing ingredient, the positioning rod 5 is adjusted to slide to an appropriate position by the adjusting mechanism 6, the ingredient is placed on the object receiving portion 11 and makes contact with the positioning rod 5; and when the positioning rod 5 is located at different positions, the slicing thickness of the ingredient will be different, such that users can slice the ingredient according to thicknesses requirements. Optionally, the adjusting mechanism 6 comprises a threaded rod 61 and a rotary knob 62, a threaded hole 52 is formed in the positioning rod 5, the threaded rod 61 is screwed into the threaded hole 52, and when the rotary knob 62 is rotated, the threaded rod 61 work together with the threaded hole 52 to allow the positioning rod 5 to slide.

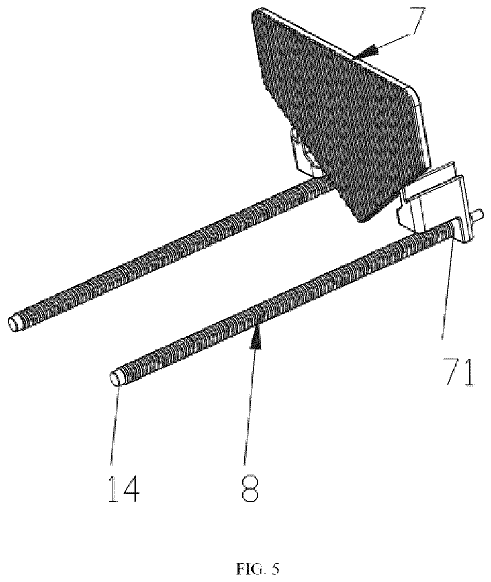

In this embodiment, referring to FIGS. 3 and 5, the kitchen slicing device further comprises a push plate 7 and springs 8, wherein the push plate 7 is slidably connected to the object receiving portion 11 to slide towards the positioning rod 5, and the springs 8 are connected between the base 1 and the push plate 7 and have a pre-tightening force for driving the push plate 7 to slide towards the positioning rod 5. When ingredient is placed between the push plate 7 and the positioning rod and the adjusting mechanism controls the positioning rod 5 to slide, the pre-tightening force of the springs keeps pushing the ingredient to be in contact with the positioning rod 5, and the ingredient does not need to be manually pushed, such that slicing is quick and convenient. Optionally, guide rods 14 are arranged on the base 1, guide rod holes 71 are formed in the push plate 7, and the guide rods 14 penetrate through the guide rod holes 71 and are able to slide along the guide rod holes 71 to slidably connect the push plate 7 to the object receiving portion 11, and the springs are disposed around the guide rods 14.

In this embodiment, referring to FIG. 3, the kitchen slicing device further comprises a scale 9, and the scale 9 is arranged on the base 1 and used for indicating the sliding distance of the positioning rod 5. The sliding distance of the positioning rod 5 can be accurately measured by means of the scale 9, such that the slicing thickness of ingredients can be accurately obtained.

The above embodiments are merely preferred ones of the invention and are not intended to limit the invention in any forms, and the protection scope of the invention is defined by the claims. Although the invention has been disclosed above with reference to preferred embodiments, the above embodiments are not used for limiting the invention, and any skilled in the art can make some modifications or embellishments to the technical contents disclosed above without departing from the scope of the technical solution of the invention to obtain equivalent embodiments. All simple modifications, equivalent transformations and embellishments made to the above embodiments according to the technical essence of the invention without departing from the contents of the technical solution of the invention should also fall within the scope of the technical solution of the invention.

What is claimed is:

1. A kitchen slicing device, comprising comprises a base, a blade and a blade holder, wherein the base is provided with an object receiving portion, the blade is mounted on the blade holder, and the blade holder is slidably connected to the base to allow the blade to slide towards the object receiving portion to complete cutting.

2. The kitchen slicing device according to claim 1, wherein the blade is detachably connected to the blade holder.

3. The kitchen slicing device according to claim 1, wherein the object receiving portion is in the form of a V-shaped groove with an opening facing upwards and is provided with anti-skid stripes.

4. The kitchen slicing device according to claim 1, wherein a guide rail is arranged on the base, and the blade holder is mounted on the guide rail and is able to slide along the guide rail.

5. The kitchen slicing device according to claim 4, wherein two said blade holders are arranged in parallel, two said guide rails are arranged in parallel correspondingly, and two ends of the blade are mounted on the two blade holders respectively; and the kitchen slicing device further comprises an inverted U-shaped pull rod, and two ends of the inverted U-shaped pull rod are connected to the two blade holders respectively.

6. The kitchen slicing device according to claim 1, further comprising a positioning rod and an adjusting mechanism, wherein the positioning rod is slidably connected to the base to slide in a direction perpendicular to the sliding direction of the blade, and the adjusting mechanism is used to adjust sliding of the positioning rod.

7. The kitchen slicing device according to claim 6, wherein the adjusting mechanism comprises a threaded rod and a rotary knob, the threaded rod is rotatably connected to the base, an internal threaded hole is formed in the positioning rod, and the threaded rod has an end connected to the rotary knob and an end screwed into the internal threaded hole.

8. The kitchen slicing device according to claim 6, wherein a sliding rod is arranged on the base, a sliding hole is formed in the positioning rod, and the sliding hole is fitted on the sliding rod to slidably connect the positioning rod to the base.

9. The kitchen slicing device according to claim 6, further comprising a push plate and a spring, wherein the push plate is slidably connected to the object receiving portion to slide towards the positioning rod, and the spring is connected between the base and the push plate, having a pre-tightening force for driving the push plate to slide towards the positioning rod.

10. The kitchen slicing device according to claim 6, further comprising a scale, wherein the scale is arranged on the base and is used for indicating a sliding distance of the positioning rod.
